(19) United States
(12) Patent Application Publication
(10) Pub. No.: US 2018/0258308 A1
(43) Pub. Date: Sep. 13, 2018

(54) COMPOSITIONS COMPRISING CERAMIC MICROSPHERES

(71) Applicant: 3M INNOVATIVE PROPERTIES COMPANY, St. Paul, MN (US)

(72) Inventors: Terri A. Shefelbine, St. Paul, MN (US); Lisa A. Brustman, Oakdale, MN (US); Kevin J. Rink, Hastings, MN (US)

(21) Appl. No.: 15/573,856

(22) PCT Filed: Jul. 13, 2016
(86) PCT No.: PCT/US2016/041961

§ 371 Date: Nov. 14, 2017

Related U.S. Application Data
(60) Provisional application No. 62/193,627, filed on Jul. 17, 2015.

(51) Int. Cl. C09D 131/04; C09D 109/06; C09D 133/06; C09D 7/40

(52) U.S. Cl. CPC C09D 131/04; C09D 109/06; C08K 7/18; C09D 7/70; C09D 133/06

(57) ABSTRACT

Described herein is a coating composition and films therefrom, wherein the coating composition comprises a plurality of ceramic microspheres wherein the plurality of ceramic microspheres has a D50 diameter of 2 to 20 microns and a D50 to D90 ratio greater than 0.50 as measured by light scattering; and at least one film-forming polymer.

### TECHNICAL FIELD

A coating composition comprising a film-forming polymer and a plurality of ceramic microspheres is described along with films made therefrom.

### SUMMARY

There is a desire to identify ways to balance performance characteristics (such as durability and appearance) of coating compositions and/or films. There is also a desire to decrease the cost of coating compositions and/or resulting films.

In one aspect, a coating composition is described comprising a plurality of ceramic microspheres wherein the plurality of ceramic microspheres has a D50 diameter of 2 to 20 microns and a D50 to D90 ratio greater than 0.50 as measured by light scattering; and at least one film-forming polymer.

In another aspect, a film is described comprising a binder and a plurality of ceramic microspheres, wherein the plurality of ceramic microspheres has a D50 diameter of 2 to 20 microns and a D50 to D90 ratio greater than 0.50 as measured by light scattering.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure relates to the use of a defined, narrow distribution of ceramic microspheres along with a film-forming polymer in a coating composition to generate a film having improved performance characteristics and/or cost.

The microspheres of the present disclosure are ceramic. As used herein “ceramic” means that the microspheres comprise a silicate-containing material.

In one embodiment, the silicate-containing material is selected from wollastonite, alkali feldspar, plagioclase feldspar, nepheline, and combinations thereof

Wollastonite is known to include at least three structural types of CaSiO₃; wollastonite, pseudowollastonite and parawollastonite. The term wollastonite, as used herein, includes any one of these three structural types and any combination of the three. In the three forms mentioned above, the wollastonites have fibrous structures attributable to their containing chains of linked SiO₄ tetrahedra of the composition (SiO₃)ₙ.

Alkali feldspar is a family of feldspars that include potassium feldspar (KAlSi₃O₈) alone or in combination in varying ratios with sodium feldspar (NaAlSi₃O₈). With respect to available ratios, see for example Dana's Manual of Mineralogy, 18th Ed., Hurlbut, C. S., John Wiley & Sons, Inc., New York, 1971, FIG. 421, p. 460. Alkali feldspar may also contain varying but usually small amounts of calcium feldspar (CaAl₂Si₂O₈). Examples of alkali feldspar include microcline, orthoclase, sanidine, adularia, albite, perthite, and anorthoclase.

Plagioclase feldspar is a series of materials comprising calcium feldspar (CaAl₂Si₂O₈) alone or in combination in any ratio with sodium feldspar (NaAlSi₃O₈), and may contain varying amounts, but usually small amounts, such as about 20% by weight or less, of potassium feldspar (KAlSi₃O₈). Examples of plagioclase feldspar include albite, oligoclase, andesine, labradorite, bytownite and anorthite.

A portion of the alkali and plagioclase feldspars are members of the ternary system NaAlSi₃O₈—KAlSi₃O₈—CaAl₂Si₃O₈. Thus, the terms alkali feldspar and plagioclase feldspar include the full rane of solid solutions of these three components which can exist in ores that can be mined.

In the present disclosure, the term “nepheline” refers to any one or combination of the members of the nepheline group, of which at least two are known. These include nepheline itself (Na₃(Na,K)[Al₄Si₄O₁₆]) and kaisilite (K[AlSiO_{4]}), in all of their crystalline structures and solid solutions with each other. The nephelines typically occur in nature in combination with the alkali feldspars, with which the nephelines are capable of forming solid solutions of varying composition.

In one embodiment, the silicate-containing material is selected from lithium silicates, alkaline earth aluminosilicates, silicon oxide, magnesium alminosilicate, hydrated aluminum silicate, and combinations thereof.

The ceramic microspheres of the present disclosure may be amorphous, glass, crystalline ceramic, glass-ceramic, substantially glassy, and combinations thereof. Substantially glassy refers to ceramic microspheres that is amorphous in nature, but may still retain some crystalline character, in other words, it is not fully amorphous. For example, if a crystalline ceramic particle is treated with the process as disclosed in U.S. Pat. No. 5,559,170 (Castle), the crystalline nature of the particle may be reduced, where the surface portions of the particle becomes amorphous in nature, however, the particle may still contain some of its original crystallinity and thus is refetTed to as substantially glassy.

The plurality of ceramic microspheres of the present disclosure are spherical in nature, meaning that ceramic microspheres have curved edges and or shapes.

The shape of the ceramic microsphere can be determined using techniques known in the art. Such a procedure for determining the size and shape of particles is described in Handbook of Mineral Dressing, by A, F^{.}, Taggart, John Wiley & Sons. Inc., New York, 1945, chapter 19, pages 118-120, Many refinements of this basic method are known to those skilled in the art. For instance, one may analyze the magnified two-dimensional images of suitably prepared samples using image analysis software in conjunction with a microscope or a source that inputs data from digital images obtained from a light microscope or SEM (scanning electron microscope).

In one embodiment, the plurality of ceramic microspheres are ellipsoidal, which means that the plurality of ceramic particles when magnified into a two-dimensional image appear generally rounded and free of sharp corners or edges, whether or not they appear to have truly or substantially circular, elliptical, globular or any other rounded shape. Thus, in addition to the truly circular and elliptical shapes, other shapes with curved but not circular or elliptical outlines are included.

In one embodiment, the plurality of ceramic microspheres are substantially spherical, which means that the plurality of ceramic particles when magnified into a two-dimensional image appear at least substantially circular. A particle will be considered substantially spherical if its outline fits within the intervening space between two, concentric, truly circular outlines differing in diameter from one another by up to about 10% of the diameter of the larger of these outlines.

A shape factor can be used to define the “roundness” of the particles. Such a shape factor measurement is defined in the Experimental Section, werein the circular shape factor (4π×area. of particle÷particlo perimeter²) is divided by the aspect ratio (largest particle dimension or diameter±smallest particle dimension or diameter). In one embodiment, the ceramic microspheres of the plurality of ceramic microspheres have an average shape factor of at least 0.65, 0.66, 0.68, 0.70, 0.80, 0.85, or even 0.90., where 1.0 is a perfect circle.

In the present disclosure, the ceramic microspheres of the present disclosure may be solid core microspheres (wherein the microsphere is not hollow), or substantially solid microspheres. In a substantially solid microsphere, the microsphere has have a hollow core, however the actual density of the microsphere is within 10%, 5%, or even 1% of the theoretical density of the microsphere assuming a solid core. In other words, the ceramic microspheres of the present disclosure are not bubbles.

The ceramic microspheres useful in the present disclosure may be transparent, translucent (partially transparent), or opaque. In one embodiment, the ceramic microspheres have an average refractive index of at least 1.4, 1.6, 1.8, 2.0, 2.2, or even 2.6.

The particle size of the ceramic microspheres can be determined based on techniques known in the art, for example, microscopy, electrical impedance, or light scattering techniques. In the present disclosure, the plurality of ceramic microspheres has a Dv50, when measured using a light scattering technique of at least 2, 5, or even 10 micrometers and at most 15, 18, or even 20 micrometers. The Dv50 measurement, or median, referred to herein as D50, is where half of the volume of particles fall above and half fall below this diameter.

The plurality of ceramic microspheres of the present disclosure has a unimodal particle size distribution. However, in one embodiment, the plurality of ceramic microspheres may have a bimodal distribution, wherein the particle size distribution curve comprises a small peak, making up less than 10%, 8%, 5%, or even 1% of the volume of the distribution, at the low end of the distribution. Although not wanting to be limited by theory it is believed that these small diameter particles adhere, perhaps due to electrostatic forces, to larger diameter particles during the sorting (e.g., sieving) process and become unattached when added to a liquid for measuring the diameter using light scattering.

The plurality of ceramic microspheres has a narrow particle size distribution. Dv90, referred to herein as D90, is the diameter on a particle size distribution curve, where 90% of the volume of particles fall below this diameter value. In the present disclosure, the plurality of ceramic microspheres has a D50 to D90 ratio greater than 0.50, 0.55, 0.60, 0.65, 0.70, 0.75, or even 0.80. The D90 measurement can be used to identify the width of the particle size distribution, where a D50 to D90 ratio of 1.0 would mean that the D90 value is the same as the D50 value.

In the present disclosure, the narrow particle size distribution can be obtained by sorting the plurality of ceramic microspheres using techniques known in the art. For example, the microspheres can be sorted via screen sieves or by an air classifier. With sieving, a screen with controlled sized openings is used and the microspheres passing through the openings are assumed to be equal to or smaller than that opening size. For microspheres, this is true because the cross-sectional diameter of the microsphere is almost always the same no matter how it is oriented to a screen opening. The microspheres can be mechanically pushed through the screen or vibration can be used to sort the microspheres through the screen. In air classifiers, air is used to separate the material based on size, shape and/or density. The particle separate based on the forces applied (such as centrifugal force and/or gravity) and their drag.

The coating composition of the present disclosure includes the plurality of ceramic microspheres and a film-forming polymer.

Film-forming polymers include those known in the art, including both synthetic and natural resins. Exemplary film-forming polymers include: acrylic (which includes both acrylic and methacrylic), acrylic copolymers (such as acrylic-styrene, vinyl/acrylic), vinyl acetate, vinyl acetate/ethylene (VAE), modified VAE, styrene-butadiene copolymer, polyesters, polyurethanes, melamine resins, epoxy, alkyds (commonly known but defined as oil modified polyesters), urea resins, silicone, and mixtures thereof Such film-forming polymers may be commercially available under the trade designations “EVOCAR” from Dow Chemical Co., Midland, Mich. and “ROVACE” from Rohm and Haas Co., a wholly owned subsidiary of Dow Chemical Co.

Depending on the coating composition, a liquid carrier may be used along with the plurality of ceramic microspheres and the film-forming polymer. The liquid carrier may be aqueous, organic, or a combination thereof

In coating compositions not comprising a liquid carrier, the amount of film-forming polymer present may be at least 20, 25, or even 30 wt %; at most 50, 60, 80, or even 95 wt % relative to the coating composition.

In coating compositions comprising a liquid carrier, such as in paints, the amount of film-forming polymer present may be at least 5, 10, 15, or even 20 wt %; at most 25, 30, 35, or even 40 wt % relative to the coating composition.

In one embodiment, the coating composition comprises at least 20, 30, 40, or even 45% by weight and at most 70, 65, or even 60% by wt of water based on the total weight of the coating composition.

In one embodiment, the coating composition may comprise an additive to improve the performance or impart various properties to the coating composition, as are known in the art. Additives may be added to modify the color, surface tension, improve flow properties, improve the finished appearance, improve the stability, impart antifreeze properties, control foaming, control skinning, etc. of the coating composition.

Examples of types of additives that may be added to the coating composition of the present disclosure, include: a pigment, a coalescent, a dye, a dispersing agent, a surfactant, a filler, preservatives (such as biocides), a defoamer, a thickner, a humectants, and combinations thereof. Additional additives include, for example, anti-corrosive pigment enhancers, curing agents, wetting agents, thickeners, rheology modifiers, plasticizers, waxes, anti-oxidants, antifoaming agents, antisettling agents, antiskinning agents, corrosion inhibitors, de hydrators, antigassing agents, driers, antistatic additives, flash corrosion inhibitors, floating and flooding additives, in-can and in-film preservatives, insecticidal additives, optical whiteners, reodorants, flatteners, de-glossing agents, ultraviolet absorbers, and the like and combinations thereof

A pigment is a particulate incorporated into the coating composition to provide opacity, color, and other optical or visual effects. Pigments are those which are known in the art. White pigments include: titanium dioxide, zinc oxide, lithopone, antimony oxide, and zinc sulfide. Non-white pigments include cadmium yellow, yellow oxides, pyrazolone orange, perinone orange, cadmium red, red iron oxide, prussian blue, ultramarine, cobalt blue, chrome green, and chromium oxide.

The amount of pigment used in the coating composition of the present disclosure is determined by the pigment's intensity and tinctorial strength, the required opacity, the required gloss, and/or the resistance and durability desired. In a paint composition, pigments may be added at least 5, 7, 10, or even 12 wt (weight) %; and no more than 18, 20, 22, 25, 27, 30, 35, or even 40wt % of a pigment is used in the total paint composition. However, more or less primary pigment may be needed, depending on the composition and the size and type of primary pigment used.

A coalescing agent is a solvent that is used to aid in the coalescence of the film-forming polymers and will evaporate upon drying of the coating composition. Coalescing agents function to externally and temporarily plasticize the film-forming polymer for a time sufficient to develop film formation, but then diffuse out of the coalesced film after film formation, which permits film formation and subsequent development of the desired film hardness by the volatilization of the coalescent. Internal plasticization is based on coreaction of soft monomers with hard monomers to form a polymeric copolymer binder, such as 80/20 vinyl acetate/butyl acrylate, to obtain the desired film-forming characteristics. Exemplary coalescing solvents include: aliphatics, aromatics, alcohols (such as isopropanol, propylene glycol, ethylene glycol, and methanol), ketones (such as trichlorethyleneacetone, methyl ethyl ketone, and methyl isobutyl ketone), white spirit, petroleum distillate, esters (such as ethyl acetate and n-isobutyl acetates), glycol ethers, perchlorethylene, volatile low-molecular weight synthetic resins, and combinations thereof, for example, ester alcohols such as that commercially available under the trade designation “EASTMAN TEXANOL” by Eastman, Kingsport, Tenn. Typically, the coalescing agent is present in a low concentration, typically less than 10, 5 or even 1 wt % based on the total coating composition.

A dispersing agent may be added to the coating composition for wetting and/or stabilization purposes. The dispersing agent can be a non-ionic or an anionic compound, typically a polymer, such polyvinyl pyrrolidone. Such dispersing agents are known in the art.

A surfactant may be added to the coating composition to reduce the surface tension and/or for stabilization purposes. The surfactant can be non-ionic, cationic, anionic, or a zwitterionic compound. Such surfactants are known in the art and include for example, those sold under the trade designation “TRITON” and “TERGITOL” by Dow Chemical Co., Midland, Mich.

The proportion of dispersing agent and/or surfactant depends upon the dispersant or surfactant or combinations used and the particular coating composition. The amount added can be determined by routine experimentation.

Fillers are usually made of inexpensive and inert materials and are added to the coating composition for various purposes, such as to thicken the composition, support its structure and simply increase the volume of the composition. For example, in paints, the fillers have little or no effect on hue, although they may reduce the chroma (that is the intensity) of the hue. They may also enhance opacity, control surface sheen, and facilitate the ease of sanding for example.

Fillers for coating compositions are known in the art. The filler can be classified as either natural or synthetic types. Exemplary fillers include: diatomaceous earth, talc, lime, clay, fine quartz sand, various clays, blanc fix, calcium carbonate, mica, silicas, aluminum silicate, magnesium silicate, barium sulphate, silica, nepheline syenite, ceramics, and talcs. Exemplary synthetics fillers include engineered molecules or polymeric structures such as “ROPAQUE ULTRA” by Dow Chemical, Midland, Mich.; glass bubbles; and the like.

Other known additives, such as metal flake and/or pearlescent pigments may be added to modify the visual characteristics of the coating composition and the resulting film.

In one embodiment, the coating composition of the present disclosure further comprises a preservative, a defoamer, a thickener, and/or a humectant. These additives are commercially available. Examples of preservatives include biocides, in particular Bronopol/(CIT/MIT). Examples of defoamers are polysiloxanes. Examples of humectants include: propylene glycol, ethylene glycol, polyethylene glycol, glycerol, sucrose, and combinations thereof. Examples of thickeners include both polymeric and inorganic and include are those sold under the trade designations “ATTAGEL” by BASF Corp., Florham Park, N.J.; “ACRYSOL RM” by Rohm and Haas, a wholly owned subsidiary of Dow Chemical, Midland, Mich.; “NATROSOL PLUS” by Ashland Inc., Covington, Ky.; and “LATTICE” by FMC BioPolymer, Philadelphia, Pa.

In the present disclosure, the plurality of ceramic microspheres and the film-forming polymer can be combined using techniques known in the art.

In one embodiment, the coating composition is a paint composition. For example, in one embodiment, the dry ingredients such as pigments and fillers are mixed with a suitable medium (such as a liquid) to form the millbase. This is the grind stage and is characterized by high shear rates. The millbase is then gradually diluted with the balance of the ingredients of the paint formulation (typically the vehicle and the film-forming polymer) and any final additives are then added to form the desired paint composition. This let down phase is characterized by lower shear rates than the grind stage.

The coating compositions of the disclosure are stable. For example, the coating compositions are stable dispersions that remain dispersed over useful time periods without substantial agitation or which are easily redispersed with minimal energy input (e.g., stirring or shaking).

As used herein, “separate” means that the solid particles in a liquid dispersion gradually settle or cream, forming distinct layers with very different concentrations of the solid particles and continuous liquid phase. For a dispersion with good dispersion stability, the particles remain approximately homogeneously distributed within the continuous phase. For a dispersion with poor dispersion stability, the particles do not remain approximately homogeneously distributed within the continuous phase and may separate. The amount of material that separates, if any, and its properties are indicative of the settling behavior of the dispersion.

In one embodiment, the coating compositions of the present disclosure have a low to zero volatile organic solvent contents (VOC). Generally speaking, such compositions will have a VOC of less than about 100 grams/liter.

In one embodiment, the coating compositions of the present invention have a viscosity allowing for ease of application. In other words, the coating composition is flowable. Depending on the coating composition, the viscosity can be measured using a Brookfield RVT viscometer using a 3, 4, 5, 6 or 7 spindle at greater than 5, 6, 8, or even 10 rpm (revolutions per minute). Preferably, the viscosity is less than about 100,000 centipoise (cP), 10000 cP, 5000 cP, 2500 cP, 2000 cP, 1500 cP, 1000cP or even 500 cP. In one embodiment, viscosities are measured with a Brookfield KU-2 Viscometer as described by ASTM method D562-10 “Standard Test Method for Consistency of Paints Measuring Krebs Unit Viscosity Using a Stormer-Type Viscometer”.

The coating compositions of the present disclosure can be applied to a surface by various means including but not limited to brushing, rolling, spraying and the like. Generally a coating is applied to a surface and forms a wet film. Examples of surfaces to which the coating composition can be applied include: wood, plastic, metal, cement, ceramic, paper, asphalt, plaster, plasterboard, previously primed or coated surfaces, and the like. The coating compositions of the present disclosure are applied such that the resulting film has a cross-sectional thickness of at least 25, 30, 40, or even 50 micrometers; and at most 100, or even 80 micrometers.

After coating, the film-forming polymer (also known as a binder) anneals (via coalescing, curing, or combinations thereof) to form a film.

In one embodiment, film formation of the coating composition occurs when the coating composition is applied to a substrate and the carrier liquid evaporates. During this process, the particles of binder (and optional pigment) come closer together. As the last vestiges of liquid evaporate, capillary action draws the binder particles together with great force, causing them to fuse into a continuous film in a process often referred to as coalescence. In coating applications such as paints, the film-forming polymer imparts adhesion, binds the pigments together, and strongly influences such properties as gloss potential, exterior durability, flexibility, and toughness.

In another embodiment, the coating composition comprises little to no liquid carrier and upon thermal or photo-initiation cures or crosslinks the binder forming a film.

In the present disclosure, it has been discovered that by using a plurality of ceramic microspheres in a coating composition with the narrow particle size distribution disclosed herein, that films can be generated that have improved performance characteristics.

Although not wanting to be limited by theory, it is believed that the use of the particular particle size distribution of the plurality of ceramic microspheres impacts the performance of the coating composition as a function of pigment volume concentration.

PVC (pigment volume concentration) is used to describe the volume ratio of all pigments (including for example primary pigment, secondary pigment, and fillers) in the coating composition to the total non-volatiles present. Typically a lower PVC value results in better durability and higher gloss of the coating composition (e.g., a paint) and a higher PVC value has a better hiding. For most coating compositions (especially in paint applications) there is a critical PVC value, wherein there is just the right amount of binder present to fill the voids of the pigment particles. Additionally, pigments and binders are expensive components of paint. Thus, it would be desirable to not use as much binder to wet-out the fillers and pigments. It has been discovered that by using the particular ceramic microspheres of the present disclosure that at high PVC values, the coating compositions comprising the narrower particle size distribution have improved performance (such as scrub, burnish and washability) as compared to the same coating composition using a broader distribution. In the present disclosure, the PVC value of the resulting film is at least 20%, 25%, 30%, 35% or even 40%; and no more than 70%, 65%, 60%, 55%, or even 50%. In another embodiment, the PVC value is at least 8%, 10%, or even 12% and no more than 18%, 20% or even 25%.

Exemplary embodiments of the present disclosure include the following.

### Embodiment 1

A coating composition comprising:
a plurality of ceramic microspheres wherein the plurality of ceramic microspheres has a D50 diameter of 2 to 20 microns and a D50 to D90 ratio greater than 0.50 as measured by light scattering; and
at least one film-forming polymer.

### Embodiment 2

The coating composition of embodiment 1, further comprising a liquid carrier.

### Embodiment 3

The coating composition of embodiment 2, wherein the liquid carrier is water.

### Embodiment 4

The coating composition of embodiment 3, wherein the water comprises 30% to 70% wt of the coating composition.

### Embodiment 5

The coating composition of any one of the previous embodiments, wherein the film-forming agent is selected from at least one of polyvinyl acetate, acrylic, styrene-butadiene copolymers, and combinations thereof.

### Embodiment 6

The coating composition of any one of the previous embodiments, wherein the ceramic microspheres in the plurality of ceramic microspheres have a shape factor of at least 0.66.

### Embodiment 7

The coating composition of any one of the previous embodiments, wherein the at least one film-forming polymer comprises 5% to 30% wt of the coating composition.

### Embodiment 8

The coating composition of any one of the previous embodiments, wherein the coating composition further comprises a dispersant, a surfactant, or combinations thereof.

### Embodiment 9

The coating composition of any one of the previous embodiments, wherein the coating composition further comprises a pigment, a dye, or combination thereof

### Embodiment 10

The coating composition of any one of the previous embodiments, wherein the coating composition further comprises a coalescent.

### Embodiment 11

The coating composition according to embodiment 10, wherein the coalescent is selected from the group consisting of: ester alcohols, alcohols, glycol ethers, and combinations thereof.

### Embodiment 12

The coating composition of any one of the previous embodiments, wherein the coating composition further comprises a filler.

### Embodiment 13

The coating composition according to embodiment 12, wherein the filler is selected from the group consisting of: ceramic microspheres, glass bubbles, calcium carbonate, clay, and combinations thereof.

### Embodiment 14

A film comprising

a binder

a plurality of ceramic microspheres wherein the plurality of ceramic microspheres has a

D50 diameter of 2 to 20 microns and a D50 to D90 ratio greater than 0.50 as measured by light scattering.

### Embodiment 15

The film of embodiment 14, further comprising an additive, wherein the additive is selected from at least one of a filler, a pigment, a rheology modifier, and a surfactant.

### Embodiment 16

The film of any one of embodiments 14-15, wherein the binder is selected from at least one of polyvinyl acetate, acrylic, styrene-butadiene copolymers, and combinations thereof.

### Embodiment 17

The film of any one of embodiments 14-16, wherein the ceramic microspheres in the plurality of ceramic microspheres have a shape factor of at least 0.66.

### Embodiment 18

The film of any one of embodiments 14-17, wherein the film has a cross-sectional thickness of 25 micrometers to 100 micrometers.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: g=gram, hr=hour, kg=kilograms, min=minutes, mol=mole; cm=centimeter, mm=millimeter, ml=milliliter, L=liter, psi=pressure per square inch, MPa=megaPascals, and wt=weight.

Test Methods

Scrub

The scrub test is a measure of the number of passes with abrasive media over a thin shim that a paint can withstand before breaking. The scrub test was performed similarly to the method described in ASTM 2486-06 (2012), except that a non-abrasive pad (available under the trade designation “3M SCOTCH-BRITE” from 3M Co., St. Paul, Minn.) was attached to the nylon brushes described therein. The breaking point was determined by observation along the edge of the shim. Two tests were run on two panels. These four values were averaged to obtain the reported values.

Burnish

The burnish test was performed similarly to the method described in ASTM 6736-08 (2013) using a 600 g weight and measuring the gloss after 100 passes. The reported value is the % change in 85° gloss as given by

$$\% change in gloss = \frac{( 85 ° {gloss}_{final} - 85 ° {gloss}_{initial} )}{85 ° {gloss}_{initial}}$$

The 85° gloss final is an average of 12 measurements, three measurements taken on four tracks.

Washability

The wash test was based on ASTM D3450-00 (2010) and used ASTM ST-1 soil as the soilant. The soilant was applied for 16 hours, blotted using a paper towel and a two pound roller, then washed with 5 mL of a 10% detergent solution (dish washing liquid available under the trade designation “DAWN” from Procter & Gamble, Cincinnati, Ohio) and 2.5 g of water for 25 passes with a sponge. The initial reflectance of the panels was measured at three points in each of two paths before the soiling and washing and the final reflectance was measured at three points in each of two paths after the washing. The ratio of the averages of these six numbers was taken to be the reflectance recovery as given in the following equation. A higher number is better and indicates more of the dark soiling was removed by washing.

$$Reflectance recovery = \frac{{Reflectance}_{final}}{{Reflectance}_{initial}}$$

Materials Table

| Material | Description |
|---|---|
| Hydroxyethyl- | Commercially available under the trade designation |
| cellulose | “NATROSOL 250 MHR” from Ashland, Covington, |
| | KY |
| Dispersant | Hydrophobic copolymer pigment dispersant commer- |
| | cially available from Dow Chemical, Midland, MI |
| | under the trade designation “TAMOL 851”. |
| Mildewcide | 45% 2-n-octyl-4-isothiazolin-3-one in propylene |
| | glycol commercially available from Dow Chemical, |
| | Midland, MI under the trade designation “SKANE |
| | M8” |
| Surfactant | Low foam nonionic surfactant commercially available |
| | from Dow Chemical, Midland, MI available under the |
| | trade designation “TRITON CF-10”. |
| Defoamer | available under the trade designation “RHODALINE |
| | 643” from Solvay Novecare |
| Pigment | Rutile titanium dioxide pigment commercially avail- |
| | able from DuPont, Wilmington, DE 2.4 g/cc true |
| | density with 1-24 micron size range available under |
| | the trade designation “TI-PURE R-06” |
| Calcined | Available under the trade designation ICEBERG |
| kaolin clay | from Burgess, Sandersville, GA |
| Ceramic | “3M CERAMIC MICROSPHERES W-410” |
| microspheres A | available from 3M Co., St. Paul, MN. |
| Ceramic | See preparation below |
| microspheres B | |
| Acrylic binder | 100% acrylic binder (45% solids) commercially avail- |
| | able from Dow Chemical, Midland, MI available under |
| | the trade designation “RHOPLEX VSR-50” |
| Coalescent | Available under the trade designation TEXANOL |
| | from Eastman, Kingsport, TN |
| Thickener | Nonionic urethane rheology modifier commercially |
| | available from Dow Chemical, Midland, MI, avail- |
| | able under the trade designation “ACRYLSOL |
| | RM - 2020 NPR” |

Preparation of Ceramic Microspheres B

Ceramic microspheres A were classified with a Model 500 classifier (CCE Technologies Inc., Cottage Grove, Minn.) operating at a feeder speed set point of 33%, a classifier speed setpoint of 1375 rpm, and a classify flow rate of 750 cubic feet per minute. The coarse material from this classification was isolated and screened according to the following process. 600.37 g of the coarse material was placed on top of a 63 □m screen on a vibratory screener (Vorti-siv, Salem, Ohio). The screener was operated at 3450 rpm for 3 minutes in the forward direction, followed by 2 minutes at 3450 rpm in the reverse direction, followed by 3 minutes at 3450 rpm in the forward direction. The yield through the screen was 591.39 g. The material passing through the screen was used in further studies.

Sizing

Sizing of the ceramic microspheres was done by laser diffraction (S3500 by Microtrac, Montgomeryville, Pa.) operating in the wet mode with water as a medium. The sample was sonicated for 60 seconds at 25% power prior to collecting the data. The data was analyzed using the laser diffraction software. The results are shown in Table 1.

Shape Factor

The shape factor of the ceramic microspheres was determined using a microscope (Leica DM LM, Leica Microsystems, Mannheim, Germany) in the transmission mode equipped with a digital camera and Leica image capture software Application Suite version 3.5.0. The samples were prepared by dispersing approximately 0.006 g of the sample in air by blowing air through a goose-neck glass tube with a large pipet bulb. The dispersed particles settled through an aluminium tube 61 cm high and 9.5 cm in internal diameter on to a clean glass microscope slide. The camera was set up using standard procedures for uniform illumination at a magnification of 40×. Multiple images were captured in grey scale at an exposure sufficient to record sharp images. An image of a blank microscope slide was digitally subtracted from each image to remove irregularities in the image caused by the camera or microscope conditions.

The digital images captured from the microscope were analyzed using Aphelion image analysis software version 4.2.0 (Amerinex Applied Imaging, Monroe Township, N.J.). The software was programed to analyze the images using the following steps. Each step was defined by functions in the software. The particles in the image were detected using the Otsu thresholding function. The inverse of the thresholded image was taken. The image was sharpened, particles touching the edge of the image were removed, and holes in particles were digitally filled. Finally the particles with overlapping convex regions were split according to an algorithm with a filter strength of 2 on a scale of 0-100.

The particles in the resulting image were measured according to calibrated pixels for their area, perimeter, and ratio of minimum to maximum Feret diameters according to definitions of these parameters commonly used in digital image analysis. From these the shape factor was calculated for each particle. From the distribution of particles observed the mean shape factor was calculated for each sample, by dividing the circular shape factor (4π×area of particle÷particle perimeter'') by the aspect ratio (largest particle dimension or diameter smallest particle dimension or diameter). The results are shown in Table 1

TABLE 1

| | | | | Shape |
|---|---|---|---|---|
| Sample | D50 | D90 | D50/D90 | Factor |
| Ceramic Microsphere A | 8.85 μm | 20.26 μm | 0.44 | 0.71 |
| Ceramic Microsphere B | 15.55 μm | 27.51 μm | 0.57 | 0.71 |

Preparation of the Grind

In a 1 gallon (3.79 L) container equipped with a 1.75 inch (44.45 mm) Cowles blade the following ingredients were added: water, dispersant, surfactant, mildewcide, and defoamer. The ingredients were stirred at 600 rpm for 3 minutes. Then potassium tripolyphosphate was added and mixed for 1 minute. Hydroxyethylcellulose was then added slowly into the container over 3 minutes and then the mixture was allowed to mix at 1000 rpm for 20 minutes. Pigment was added in small portions and was allowed to mix after each portion addition. The Calcined kaolin clay was added followed by the ceramic microspheres. The amounts of each component are shown in Table 2. The addition of the pigment, calcined kaolin clay, and the ceramic microspheres took 14 minutes. For Comparative Example A, the mixer then was turned up to 2300 rpm and the grind mixed for 21 minutes. For Example 1, the mixer was turned to 24000 rpm and the grind mixed for 20 minutes.

Preparation of the Let-down

In a 2 quart (0.95L) jar, the following ingredients were added and mixed for 15 minutes using a propeller blade with a vortex pulling about 1 inch (25.4 mm) into the liquid: acrylic binder, defoamer, coalescent, and propylene glycol.

Comparative Example A (CE A) and Example 1 (Ex1)

The Grind and Let-down were prepared as described above, using the amounts of components listed in Table 2 below for Comparative Example A and Example 1.

TABLE 2

| | CE A | Ex 1 |
|---|---|---|
| | weight (g) | weight (g) |
| Grind | | |
| Hydroxyethylcellulose | 6.36 | 5.87 |
| water | 597.80 | 551.91 |
| Dispersant | 25.33 | 23.38 |
| Mildewcide | 5.43 | 5.01 |
| Potassium | 3.79 | 3.50 |
| tripolyphosphate | | |
| Surfactant | 5.55 | 5.12 |
| Defoamer | 2.52 | 2.33 |
| Pigment | 442.63 | 408.65 |
| Calcined kaolin clay | 221.66 | 204.64 |
| Ceramic microspheres, | A | B |
| type and amount | 388.93 | 389.59 |
| Let-down | | |
| Acrylic binder | 1143.42 | 1143.42 |
| Defoamer | 10.33 | 10.33 |
| Coalescent | 27.38 | 27.38 |
| propylene glycol | 18.87 | 18.87 |

An amount of the Grind, an amount of the Let-down, and an amount of Thickener were mixed together using a propeller mixer to make a paint having various PVC (Pigment volume concentrations). The paint was mixed for at least 10 minutes after the last addition of Thickener. The amounts (in grams) for the Grind, Let-down, and Thickener used in each sample are shown in Table 3.

TABLE 3

| | PVC | Grind (g) | Let-down (g) | Thickener (g) |
|---|---|---|---|---|
| CE A | 30 | 220.53 | 279.47 | 3.99 |
| | 40 | 275.53 | 224.47 | 2.82 |
| | 45 | 300.51 | 199.49 | 2.01 |
| | 50 | 324.02 | 175.98 | 1.83 |
| | 60 | 367.08 | 132.92 | 1.24 |
| Ex 1 | 30 | 219.86 | 280.14 | 3.99 |
| | 40 | 278.36 | 225.14 | 2.77 |
| | 45 | 299.86 | 200.14 | 2.13 |
| | 50 | 323.4 | 176.6 | 1.86 |
| | 60 | 366.56 | 133.44 | 1.91 |

The resulting paints were drawn onto PVC panels using a 7 mil (0.178 mm) drawdown bar. One drawdown was made for each paint on a sealed Leneta 3B chart with a 3 mil bird bar to measure opacity. The painted panels were allowed to dry at ambient conditions in the horizontal position for at least 7 days before testing. The dried panels were then tested for scrub, burnish, and washability according to the methods above. The results for each paint are shown in Table 4.

TABLE 4

| | | | Burnish (% | Washability |
|---|---|---|---|---|
| | | Scrub (number | change in 85 | (reflectance |
| PVC | | of passes) | degree gloss) | ratio recovery) |
| 30 | CE A | 1366 | 32 | 0.83 |
| | Ex 1 | 1394 | 20 | 0.92 |
| 40 | CE A | 1302 | 64 | 0.57 |
| | Ex 1 | 1479 | 39 | 0.68 |
| 45 | CE A | 1237 | 84 | 0.45 |
| | Ex 1 | 1465 | 52 | 0.57 |
| 50 | CE A | 905 | 90 | 0.33 |
| | Ex 1 | 1399 | 71 | 0.42 |
| 60 | CE A | 646 | 56 | 0.24 |
| | Ex 1 | 731 | 72 | 0.25 |

As shown in Table 4 above, at almost every pigment volume concentration, the samples made with the narrow particle size distribution of ceramic microspheres had improved scrub (i.e., more passes until failure), improved burnish (i.e., lower % change), and improved washability (i.e., a higher reflectance ratio recovery) as compared to CE A.

Foreseeable modifications and alterations of this invention will be apparent to those skilled in the art without departing from the scope and spirit of this invention. This invention should not be restricted to the embodiments that are set forth in this application for illustrative purposes.

1. A coating composition comprising
(a) a plurality of ceramic microspheres wherein the plurality of ceramic microspheres has a
D50 diameter of 2 to 20 microns and a D50 to D90 ratio greater than 0.50 as measured by light scattering; and
(b) at least one film-forming polymer.

2. The coating composition of claim 1, further comprising a liquid carrier.

3. The coating composition of claim 2, wherein the liquid carrier is water.

4. The coating composition of claim 3, wherein the water comprises 30% to 70% wt of the coating composition.

5. The coating composition of claim 1, wherein the film-forming agent is selected from at least one of polyvinyl acetate, acrylic, styrene-butadiene copolymers, and combinations thereof.

6. The coating composition of claim 1, wherein the ceramic microspheres in the plurality of ceramic microspheres have a shape factor of at least 0.66.

7. The coating composition of claim 1, wherein the at least one film-forming polymer comprises 5% to 30% wt of the coating composition.

8. A film comprising
(a) a binder
(b) a plurality of ceramic microspheres wherein the plurality of ceramic microspheres has a
D50 diameter of 2 to 20 microns and a D50 to D90 ratio greater than 0.50 as measured by light scattering.

9. The film of claim 8, wherein the binder is selected from at least one of polyvinyl acetate, acrylic, styrene-butadiene copolymers, and combinations thereof.

10. The film of claim 8, wherein the film has a cross-sectional thickness of 25 micrometers to 100 micrometers.

11. The coating composition of claim 1, wherein the coating composition further comprises a dispersant, a surfactant, or combinations thereof

12. The coating composition of claim 1, wherein the coating composition further comprises a pigment, a dye, or combination thereof.

13. The coating composition of claim 1, wherein the coating composition further comprises a coalescent.

14. The coating composition of claim 1, according to claim 13, wherein the coalescent is selected from the group consisting of: ester alcohols, alcohols, glycol ethers, and combinations thereof.

15. The coating composition of claim 1, wherein the coating composition further comprises a filler.

16. The coating composition according to claim 15, wherein the filler is selected from the group consisting of: ceramic microspheres, glass bubbles, calcium carbonate, clay, and combinations thereof.

17. The film of claim 8, further comprising an additive, wherein the additive is selected from at least one of a filler, a pigment, a rheology modifier, and a surfactant.

18. The film of claim 8, wherein the ceramic microspheres in the plurality of ceramic microspheres have a shape factor of at least 0.66.
